(19) United States
(12) Patent Application Publication
(10) Pub. No.: US 2008/0114471 A1
(43) Pub. Date: May 15, 2008

(54) Display method for supervisory control system

(75) Inventor: Hiroyuki Koyama, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/976,571

(22) Filed: Oct. 25, 2007

(30) Foreign Application Priority Data
Nov. 15, 2006 (JP) 2006-309188

(51) Int. Cl. G05B 15/02; G06F 3/14

(52) U.S. Cl. 700/1; 715/200

(57) ABSTRACT

A display method for a supervisory control system that displays on a display screen a result of the interlock judgment for judging the ability of a control operation on each machine under supervisory control from the state information of multiple machines under supervisory control subject to supervisory control by the supervisory control system, includes the steps of performing interlock judgment in advance independently of the control operation, and, upon the control operation, displaying the result of the interlock judgment on a display screen, which displays the machines under supervisory control in advance.

### BACKGROUND OF THE INVENTION

1. Field of the Invention

The present invention relates to a display method for a supervisory control system that monitors and controls a machine under supervisory control for example in a plant.

2. Description of the Related Art

In order to control multiple machines under supervisory control by a supervisory control system, an interlock condition (which is a combination of states of a different machine under supervisory control, which relates to the present machine under supervisory control, and an alarm) defined for each machine under supervisory control is judged. If the judgment results in “uncontrollable”, the control is blocked.

In a conventional supervisory control system, when an operator performs a control operation for controlling a machine under supervisory control, the interlock is not judged until a series of operations for the machine under supervisory control is started. Therefore, the interlock judgment result on the machine under supervisory control is not displayed near the symbol of a machine under supervisory control, which is displayed on a screen, until a series of control operations for the machine under supervisory control is started (refer to Patent Document 1).

Patent Document 1: JP-A-2001-142527 (Paragraph No. 0073)

Since the interlock is not judged until a series of control operations for a machine under supervisory control is started by an operator on a supervisory control system in the past, the operator may perform an unnecessary wasteful control operation if the interlock judgment results in “uncontrollable”.

### SUMMARY OF THE INVENTION

The invention was made in view of the real situation, and it is an object of the invention to eliminate the necessity for performing an unnecessary wasteful control operation by an operator.

According to the invention, there is provided a display method for a supervisory control system that displays on a display screen a result of the interlock judgment for judging the ability of a control operation on each of multiple machines under supervisory control from the state information of the multiple machines under supervisory control subject to supervisory control by the supervisory control system, the method including the steps of performing interlock judgment in advance independently of the control operation, and, upon the control operation, displaying the result of the interlock judgment on a display screen, which displays the machines under supervisory control in advance. Therefore, since the interlock judgment result on the controllability is notified to an operator before the operator performs a control operation on the machine under supervisory control, the necessity for performing a wasteful operation may be eliminated if the interlock judgment results in “uncontrollable”.

The foregoing and other object, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a first embodiment of the invention and is a block diagram showing an example of the system configuration of the supervisory control system having an interlock judgment display function;

FIG. 2 is a diagram showing the first embodiment of the invention and is a diagram showing an example of the construction of an interlock data file of a machine under supervisory control to be controlled;

FIG. 3 is a diagram showing the first embodiment of the invention and is a diagram showing an example of the construction of an interlock database; and

FIG. 4 is a diagram showing the first embodiment of the invention and is a diagram showing an example of the display of an interlock judgment result.

### DESCRIPTION OF THE PREFERRED EMBODIMENTS

### First Embodiment

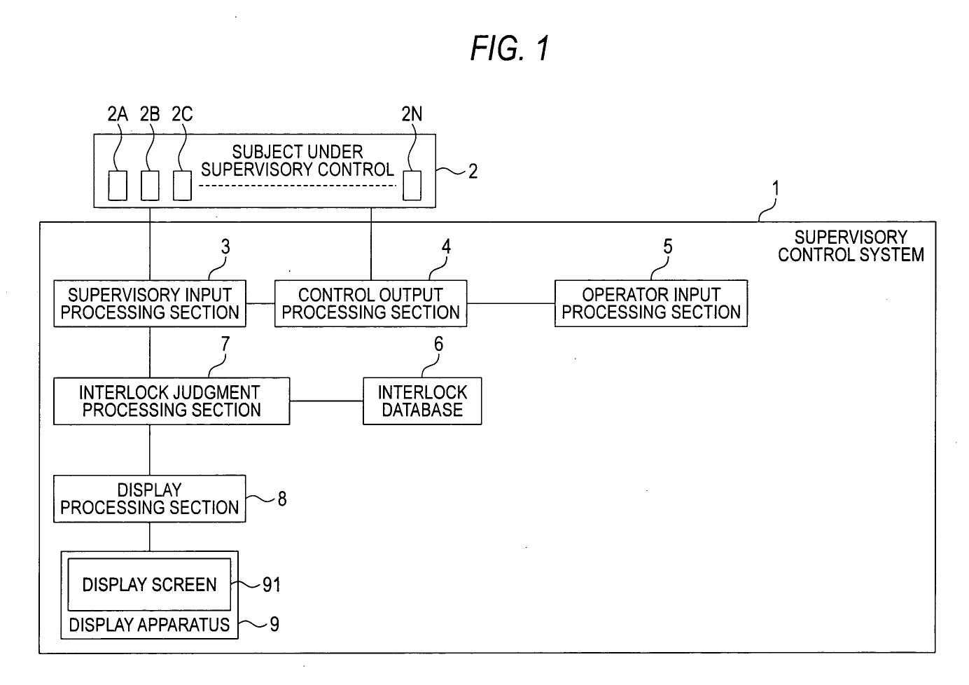

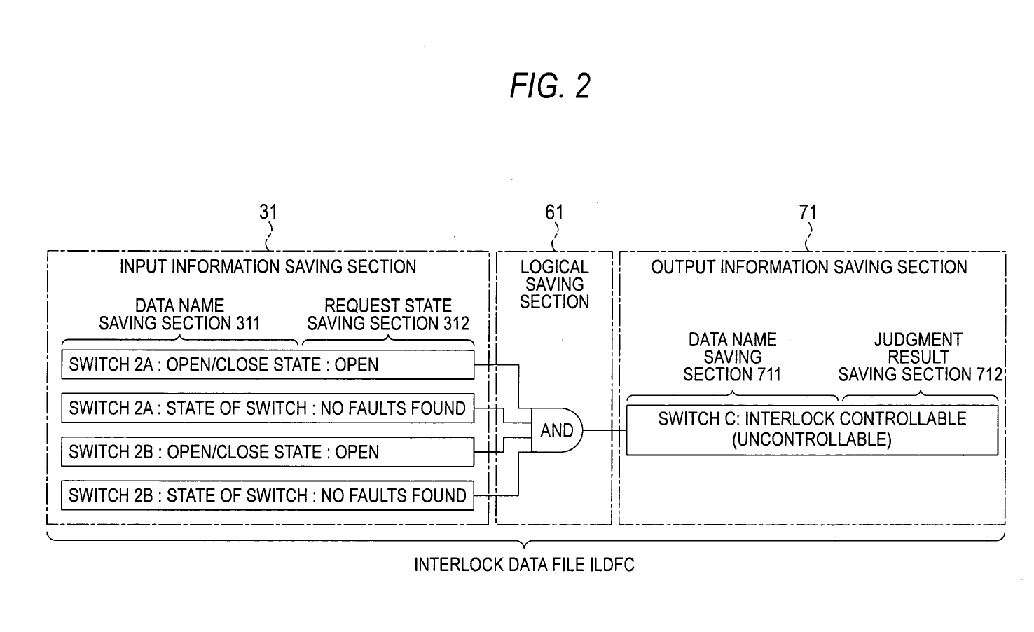

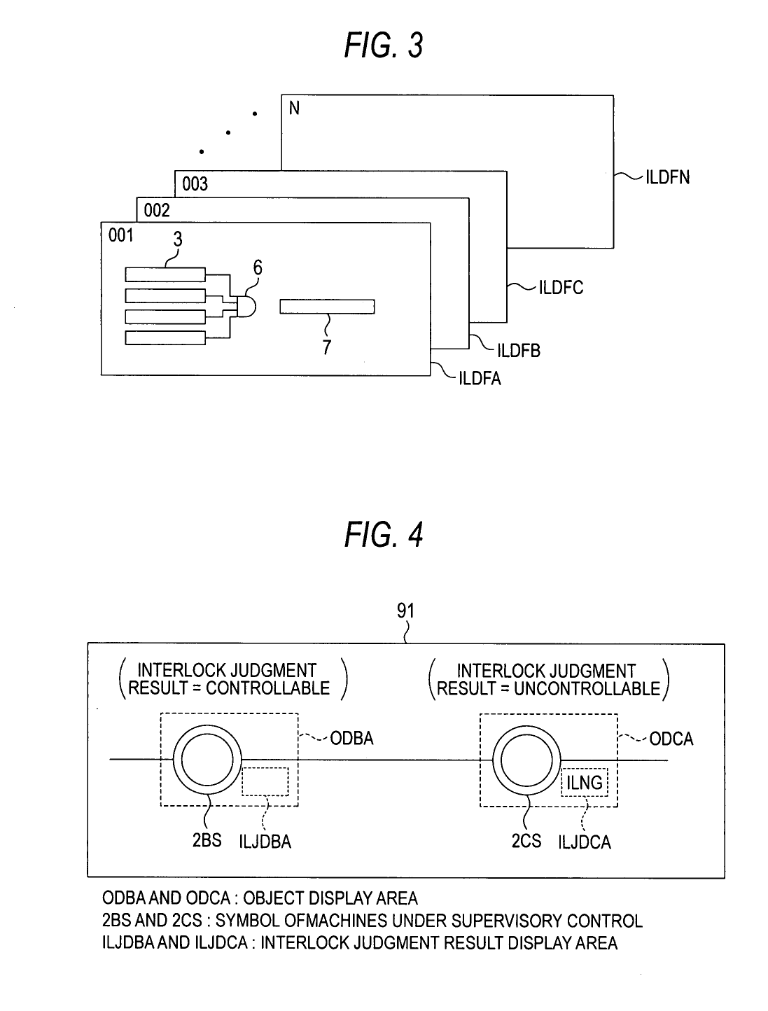

With reference to FIGS. 1 to 4, a first embodiment of the invention will be described below. FIG. 1 is a block diagram showing an example of the system configuration of the supervisory control system having an interlock judgment display function. FIG. 2 is a diagram showing an example of the construction of an interlock data file of a machine under supervisory control to be controlled. FIG. 3 is a diagram showing an example of the construction of an interlock database. FIG. 4 is a diagram showing an example of the display of an interlock judgment result. Identical reference numerals are given to identical components in the figures.

In FIGS. 1 to 4, a supervisory control system 1 monitors and controls multiple machines under supervisory control 2A, 2B, 2C, . . . and 2N in a subject under supervisory control 2 such as a plant such as a power plant, an electric supply station and a substation.

The supervisory control system 1 includes, as illustrated in FIG. 1, a supervisory input processing section 3, a control output processing section 4, an operator input processing section 5, an interlock database 6, an interlock judgment processing section 7, a display processing section 8 and a display apparatus 9. The display apparatus 9 has a display screen 91.

The supervisory input processing section 3 receives and saves the inputs of data of states of the machines under supervisory control 2A, 2B, 2C, . . . and 2N from the machines under supervisory control.

The control output processing section 4 receives the input of the output of the operator input processing section 5 that receives the input based on the control operation from an operator and outputs the control over the machines under supervisory control 2A, 2B, 2C, . . . and 2N based on the input of the control operation by the operator.

The interlock database 6 may be an interlock database, for example, as shown in FIG. 3, which will be described later, having an interlock data file as illustrated in FIG. 2, which will be described later.

The interlock judgment processing section 7 performs interlock judgment on each of the machines under supervisory control 2A, 2B, 2C, . . . and 2N based on the interlock related information retrieved from the interlock database 6 and the interlock-related state information of the machines under supervisory control 2A, 2B, 2C, . . . and 2N retrieved from the supervisory input processing section 3.

More specifically, in the interlock database 6, each of the machines under supervisory control 2A, 2B, 2C, . . . and 2N, respectively, of all of the machines under supervisory control 2A, 2B, 2C, . . . and 2N requiring the interlock has interlock data files ILDFA, ILDFB, ILDFC, . . . and ILDFN of the machines under supervisory control 2A, 2B, 2C, . . . and 2N, as shown in FIG. 3. The interlock data files ILDFA, ILDFB, ILDFC, . . . and ILDFN are created in advance.

The interlock data files ILDFA, ILDFB, ILDFC, . . . and ILDFN of each of the machines under supervisory control 2A, 2B, 2C, . . . , and 2N are stored in the interlock database 6 with ID numbers 001, 002, 003, . . . and N for identifying the interlock data files ILDFA, ILDFB, ILDFC, . . . and ILDFN, respectively, as shown in FIG. 3.

FIG. 2 typically shows the structure of the interlock data file ILDFC among the interlock data files ILDFA, ILDFB, ILDFC, . . . and ILDFN of the machines under supervisory control 2A, 2B, 2C, . . . and 2N, respectively. FIG. 2 shows a case where the machines under supervisory control 2A, 2B and 2C are switches A, B and C, respectively.

As illustrated in FIG. 2, in the interlock data file ILDFC, the data of the requested states to be handled as a judgment criteria (interlock condition) for performing the interlock judgment on the controllability of the machine under supervisory control 2C are saved including the data of “open” of the open/close state of the switch 2A, the data of “no faults found” of the states of the switch 2A, the data of “open” of the open/close state of the switch 2B, and the data of “no faults found” of the states of the switch 2B in the area of a requested state saving section 312 of an input information saving section 31 as the open/close state of the switch 2A (that is, machine under supervisory control 2A), the state of the switch 2A (that is, machine under supervisory control 2A), the open/close state of the switch 2B (that is, machine under supervisory control 2B), and the state of the switch 2B (that is, machine under supervisory control 2B), respectively.

The names of data of the open/close state of the switch 2A (that is, machine under supervisory control 2A), the state of the switch 2A (that is, machine under supervisory control 2A), the open/close state of the switch 2B (that is, machine under supervisory control 2B), and the state of the switch 2B (that is, machine under supervisory control 2B) are saved in the area of a data name saving section 311 of the input information saving section 31. Notably, the names of data may be ID numbers, for example, if data is uniquely identifiable thereby.

The interlock data file ILDFC has a logical saving section 61 and an output information saving section 71.

The logical saving section 61 saves a logical expression (that is, a logical expression for performing an operation by an interlock judgment function such as the shown AND logic circuit) for performing, in the interlock judgment processing section 7 a logic operation regarding whether the judgment criteria (interlock condition) agrees with the real open/close state of the switch 2A (that is, machine under supervisory control 2A), the real state of the switch 2A (that is, machine under supervisory control 2A), the real open/close state of the switch 2B (that is, machine under supervisory control 2B), and the real state of the switch 2B (that is, machine under supervisory control 2B), which are saved in the supervisory input processing section 3.

The output information saving section 71 saves data of the result (controllable or uncontrollable) of the interlock judgment by performing, by the interlock judgment processing section 7 based on the logic expression, a logic operation regarding whether the judgment criteria (interlock condition) agrees with the real open/close state of the switch 2A (that is, machine under supervisory control 2A), the real state of the switch 2A (that is, machine under supervisory control 2A), the real open/close state of the switch 2B (that is, machine under supervisory control 2B), and the real state of the switch 2B (that is, machine under supervisory control 2B), which are saved in the supervisory input processing section 3.

According to the first embodiment, each of the other interlock data files ILDFA, ILDFB, ILDFC (not shown), . . . and ILDFN has the same construction as that of the interlock data file ILDFC.

In other words, the interlock judgment processing section 7 performs the interlock judgment on each of the machines under supervisory control 2A, 2B, 2C, . . . and 2N based on the judgment criteria (interlock conditions) of the interlock data files ILDFA, ILDFB, ILDFC, . . . and ILDFN, respectively, in the interlock database 6 and the logic expression from the state information of the machines under supervisory control 2A, 2B, 2C, . . . and 2N, which are retrieved from the supervisory input processing section 3. Then, the judgment results are saved in the output information saving section 71 in the respective interlock data files ILDFA, ILDFB, ILDFC, . . . and ILDFN.

According to the first embodiment, as illustrated in FIG. 2, if all of four conditions including the data of “open” of the open/close state of the switch 2A, the data of “no faults found” of the states of the switch 2A, the data of “open” of the open/close state of the switch 2B, and the data of “no faults found” of the states of the switch 2B, are satisfied, the switch 2C is “controllable” as a result of the interlock judgment.

According to the first embodiment, the interlock judgment may be performed normally periodically at predetermined time intervals without limiting to the time when the control operation is started, the time when the control operation mode is selected and the control operation. The judgment result is also saved in the output information saving section 71 every time. The latest interlock judgment result is always saved in the output information saving section 71.

The symbols of the machines under supervisory control 2A, 2B, 2C, . . . and 2N are displayed on the screen 91 (more specifically, on the initial screen displayed on the screen 91 when a control operation is started or when the control operation mode is selected) in a manner that the currently latest interlock judgment results are displayed adjacent to or over the displayed symbols of the machines under supervisory control 2A, 2B, 2C, . . . and 2N when the symbols of the machines under supervisory control 2A, 2B, 2C, . . . and 2N are displayed.

The display processing section 8 saves changeable setting data such as information pieces 2AS (not shown), 2BS, 2CS, . . . and 2nS (not shown) of the symbols of the machine under supervisory control 2A, 2B, 2C, . . . and 2N, object display areas ODAA (not shown), ODBA, ODCA, . . . and ODnA (not shown) of the respective machines under supervisory control and interlock judgment result display areas ILJDAA (not shown), ILJDBA, ILJDCA, . . . and ILJDnA (not shown) defined adjacent to or over the respective symbols within the object display areas, as shown in FIG. 4, and causes the display screen 91 to display on the initial screen of a supervisory mode or the initial screen before a control operation in a control operation mode, for example, as illustrated in FIG. 4, for example, symbol information pieces 2AS (not shown), 2BS, 2CS, . . . and 2nS (not shown), object display areas ODAA (not shown), ODBA, ODCA, . . . and ODnA (not shown), interlock judgment result display areas ILJDAA (not shown), ILJDBA, ILJDCA, . . . and ILJDnA (not shown) and an interlock judgment result ILNG (uncontrollable).

According to the first embodiment, FIG. 4 shows a case where the interlock judgment result, “controllable”, may not be displayed on the screen. In the case in FIG. 4, the result of the interlock judgment of the machine under supervisory control 2B such as the switch is “controllable”, and the symbol information piece 2BS of the machine under supervisory control 2B such as the switch is displayed within the object display area ODBA as shown in FIG. 4. The indication for “controllable” is not displayed in the interlock judgment result display area ILJDBA. The result of the interlock judgment of the machine under supervisory control 2C such as the switch is “uncontrollable”, and the symbol information piece 2CS of the machine under supervisory control 2C such as the switch is displayed within the object display area ODCA. The indication for “uncontrollable” is displayed as ILNG in the interlock judgment result display area ILJDCA adjacent to the display symbol information piece 2CS.

Next, an operation by the interlock judgment processing section 7 will be described in detail.

In a first step, the interlock judgment processing section 7 loads interlock related data of an interlock data file with ID=001, for example, from the interlock database 6.

In a second step, the data on the current state (latest state) of the machine under supervisory control 2C corresponding to the data name saved in the input information saving section 311 of the loaded interlock related data is loaded from the supervisory input processing section 3.

In a third step, if the current state corresponding to the data (open/close state of the switch 2A in FIG. 2, for example) of the data name saved in the input information saving section 311 of the interlock related data agrees with the requested state, the input end of the corresponding logic circuit (that is, the highest input end of AND logic elements in FIG. 2, for example) is turned on. If not, the corresponding input end is turned off.

In a fourth step, after the ON/OFF is determined as described above for all of the data under the data names saved in the input information saving section 311 of the interlock related data, the interlock judgment is performed in accordance with the sequence (logical expression) of the logic circuit in FIG. 2. If the output end of the logic circuit is ON (that is, the operation result by the logical expression is ON), the judgment result of the output information saving section 71 is “controllable”. If the output end of the logic circuit is OFF (that is, the operation result by the logical expression is OFF), the judgment result of the output information saving section 71 is “uncontrollable”.

In a fifth step, after the interlock judgment as described above is finished on the interlock data file ILDFA with ID=001, the interlock judgment is next performed on the interlock data file ILDFB with ID=002 in the same manner.

After that, the interlock judgment is performed on the files up to the interlock data file ILDFN with ID=N (where N is the highest interlock ID of the interlock data stored in the interlock database). After the interlock judgment is finished on the interlock data file ILDFN with ID=N, the processing returns to the interlock judgment on the interlock data file ILDFA with ID=001 again and is repeated.

The display processing section 8 normally monitors at all times the states of the machines under supervisory control 2A, 2B, 2C, . . . and 2N input to the supervisory input processing section 3 and changes the display state of the corresponding symbol if any change occurs in state. In addition, the display processing section 8 monitors the interlock database 6 at all times. If any change occurs in the interlock judgment result in the output information saving section 71 in the interlock database 6, the display in the interlock judgment result display area adjacent to the display symbol of the corresponding machine under supervisory control is changed.

The first embodiment is, as described above, a display method for a supervisory control system that displays on a display screen the result of the interlock judgment that judges the ability of a control operation of each machine under supervisory control based on the state information of multiple machines under supervisory control subject to supervisory control by the supervisory control system. In this case, the interlock judgment is performed in advance independently of the control operation, and, upon the control operation, the result of the interlock judgment is displayed on the display screen, which displays the machine under supervisory control in advance. In the display method for a supervisory control system, the interlock judgment result is displayed along with the display of the corresponding machine under supervisory control, and the interlock judgment is performed normally periodically.

Thus, since the interlock judgment result for each machine under supervisory control is normally displayed in accordance with the change in states of the machines under supervisory control, the interlock judgment result of each machine under supervisory control can be notified to an operator before the operator starts a control operation. Therefore, the necessity for performing an unnecessary operation can be advantageously eliminated if the interlock judgment result is “uncontrollable”.

### Second Embodiment

Having illustrated, according to the first embodiment, the case where the interlock judgment is normally repeated even if no change occurs in the states of the machines under supervisory control 2A, 2B, 2C, . . . and 2N input to the supervisory input processing section 3, the interlock judgment is performed only on the interlock related data relating to the change in state if any change occurs in the states of the machines under supervisory control 2A, 2B, 2C, . . . and 2N according to a second embodiment.

From a different point of view, the second embodiment is a display method for a supervisory control system in which the interlock judgment is performed again when any change occurs in input information for performing the interlock judgment.

More specifically, for example, the second embodiment is performed as follows. That is, the supervisory input processing section 3 receives the machine's states or fault information on the machines under supervisory control 2A, 2B, 2C, . . . and 2N as input data. The interlock judgment processing section 7 searches through the interlock database 6 the presence of the interlock related data having, in the input information saving section 31, the data with the name agreeing with the data name of each of the input data received by the supervisory input processing section 3. If no interlock related data hits, it is determined that no interlock related data requires the interlock judgment. Therefore, the interlock judgment processing is not performed. If any interlock related data hits, the interlock judgment is performed on the interlock related data.

Thus, if any change occurs in states, the interlock judgment is performed only on the related interlock related data. Therefore, the all-time display of the interlock judgment result and the minimization of the load of processing on the system can be achieved at the same time.

### Third Embodiment

The same advantages as those of the first and second embodiments can be obtained from other display methods if an operator can clearly distinguish between the states “controllable” and “uncontrollable” though, according to the first and second embodiments, the interlock judgment result is displayed in an interlock judgment result display area next to the display symbols of the machines under supervisory control 2A, 2B, 2C, . . . and 2N, and “ILNG” is displayed if the interlock judgment result is “uncontrollable”.

For example, the invention is applicable to followings:

The interlock judgment result may be indicated by a sub-symbol instead of text. For example, a different symbol indicating an interlock judgment result may be displayed near the symbol of the machine under supervisory control.

The color of the symbol itself of the machine under supervisory control may be changed. For example, if the interlock judgment result is “controllable”, the color of the symbol itself of the machine under supervisory control may be “blue”, for example. If the interlock judgment result is “uncontrollable”, the color of the symbol itself of the machine under supervisory control may be “red”, for example.

The color of the background of the symbol of the machine under supervisory control maybe changed. For example, in FIG. 4, the symbol 2BS of the machine under supervisory control may be displayed over the object display area ODBA. Then, for example, the color of the object display area ODBA at the back functioning as the background may be “blue” if the interlock judgment result is “controllable” and may be “red” if the interlock judgment result is “uncontrollable”.

The symbol of the machine under supervisory control may be shaded. For example, in FIG. 4, the object display area ODBA may be displayed over the symbol 2BS of the machine under supervisory control, and the object display area ODBA at the front may be shaded in “blue” if the interlock judgment result is “controllable” and may be shaded in “red” if the interlock judgment result is “uncontrollable”.

The form of the symbol itself of the machine under supervisory control may be changed. For example, the form of the symbol may be a circle if the interlock judgment result is “controllable” and may be a square if the interlock judgment result is “uncontrollable.

The symbol of the machine under supervisory control may be displayed continuously if the interlock judgment result is “controllable” and may be caused to flash if the interlock judgment result is “uncontrollable”.

Various modifications and alterations of this invention will be apparent to those skilled in the art without departing from the scope and spirit of this invention, and it should be understood that this is not limited to the illustrative embodiments set forth herein.

What is claimed is:

1. A display method for a supervisory control system that displays on a display screen a result of the interlock judgment for judging the ability of a control operation on each of multiple machines under supervisory control from the state information of the multiple machines under supervisory control subject to supervisory control by the supervisory control system, the method comprising the steps of:
performing interlock judgment in advance independently of the control operation; and
upon the control operation, displaying the result of the interlock judgment on a display screen, which displays the machines under supervisory control in advance.

2. The display method for a supervisory control system according to claim 1, wherein the interlock judgment result is displayed along with the display of a machine under supervisory control.

3. The display method for a supervisory control system according to claim 1, wherein the interlock judgment is normally periodically performed.

4. The display method for a supervisory control system according to claim 2, wherein the interlock judgment is normally periodically performed.

5. The display method for a supervisory control system according to claim 1, wherein the interlock judgment is performed again when a change occurs in the input information for performing the interlock judgment.

6. The display method for a supervisory control system according to claim 2, wherein the interlock judgment is performed again when a change occurs in the input information for performing the interlock judgment.
